(19) United States
(12) Patent Application Publication
(10) Pub. No.: US 2016/0170455 A1
(43) Pub. Date: Jun. 16, 2016

(54) ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: PENG LIU, Wuhan (CN)

(21) Appl. No.: 14/611,927

(22) Filed: Feb. 2, 2015

(30) Foreign Application Priority Data
Dec. 12, 2014 (CN) 201410761124.1

(51) Int. Cl. G06F 1/20

(52) U.S. Cl. CPC G06F 1/20

(57) ABSTRACT

An electronic device includes a rear cover, an air duct, and a bracket configured to receive a HDD. The rear cover has a through hole. The bracket is mounted to the rear cover. The air duct is located between the rear cover and the bracket. The air inlet is communicated with the through hole, and the air outlet is aligned with the bracket. An air path is defined by the through hole, the air inlet, the air outlet, and the bracket.

### CROSS-REFERENCE TO RELATED APPLICATIONS

This application claims priority to Chinese Patent Application No. 201410761124.1 filed on Dec. 12, 2014, the contents of which are hereby incorporated by reference.

### FIELD

The subject matter herein generally relates to an electronic device, and more particularly to an electronic device which can be used for quickly dissipating heat from a hard disk drive.

### BACKGROUND

A hard disc drive (HDD) is an important storage device in an electronic device. Heat is generated by the HDD when the electronic device is operating.

### BRIEF DESCRIPTION OF THE DRAWINGS

Implementations of the present technology will now be described, by way of example only, with reference to the attached figures.

FIG. 1 is an exploded, isometric view of an electronic device in accordance with an embodiment.

FIG. 2 is a partially assembled, isometric view of the electronic device of FIG. 1.

FIG. 3 is a cross-sectional view of FIG. 2, taken along a line III-III.

FIG. 4 is an assembled, isometric view of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

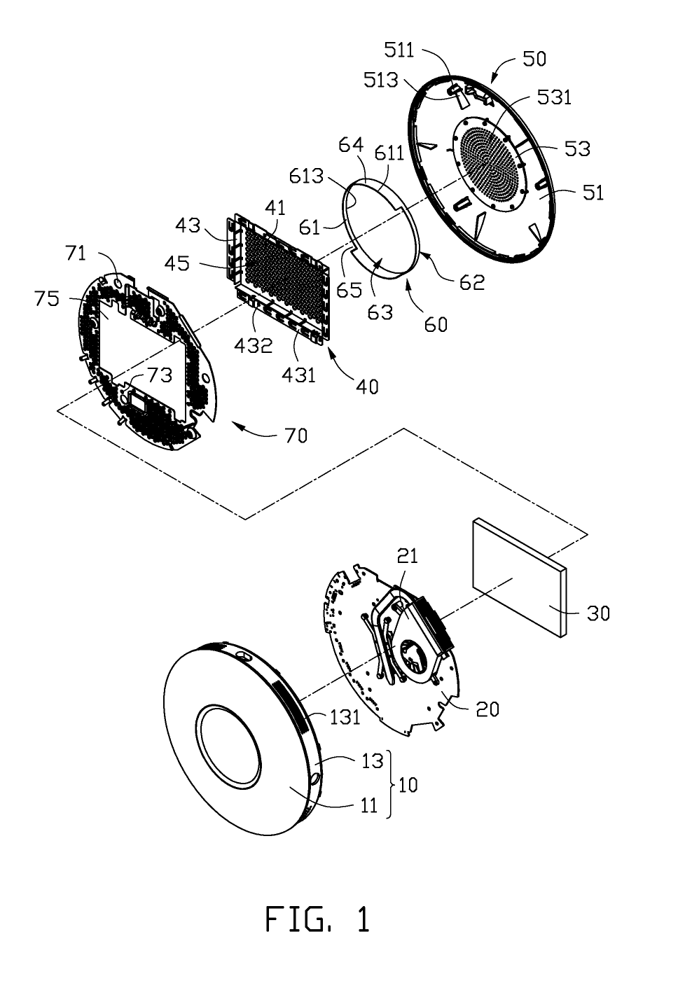

FIG. 1 illustrates an electronic device including a front cover 10, a circuit board 20, a HDD (hard disk drive) 30, a bracket 40, and a rear cover 50.

The front cover 10 includes a front panel 11 and a sidewall 13 perpendicularly connected to the front panel 11. In at least one embodiment, the front panel 11 is substantially circular, and the sidewall 13 is substantially annular. The sidewall 13 defines a vent 131.

A fan 21 is mounted on the circuit board 20 and configured to dissipate heat from the HDD 30.

The bracket 40 includes a bottom plate 41 and four side plates 43 connected to the bottom plate 41. A receiving space 45 is defined between the bottom plate 41 and side plates 43. A flange 431 extends from a top end of each side plate 43, and each flange 431 defines a latching hole 432.

The rear cover 50 includes a rear panel 51. The rear panel 51 is substantially circular. A plurality of mounting posts 511 and retaining pieces 513 extend from the rear panel 51. The rear cover 50 further includes a baffle plate 53 mounted on the rear panel 51. The baffle plate 53 is substantially circular. The baffle plate 53 defines a through hole 531, and airflow can flow into the electronic device via the through hole 531.

The electronic device further includes an air duct 60 which is substantially annular. An inner diameter of the air duct 60 is substantially equal to that of the baffle plate 53. The air duct 60 includes a main body 61, an air inlet 62, and an air outlet 63. The main body 61 includes a top edge 611 and a bottom edge 613. The air inlet 62 is surrounded by the bottom edge 613. The air outlet 63 is surrounded by the top edge 611. The air duct 60 further includes two symmetrically clamping pieces 64 and two notches 65. In at least one embodiment, the main body 61 is cut to form the clamping pieces 64 and the notches 65.

The electronic device further includes a shielding cover 70. The shielding cover 70 defines a plurality of mounting holes 71 corresponding to the mounting posts 511 and a plurality of securing holes 73 corresponding to the latching holes 432. The shielding cover 70 further defines an opening 75 for mounting the HDD 30 in the receiving space 45 of the bracket 40 conveniently.

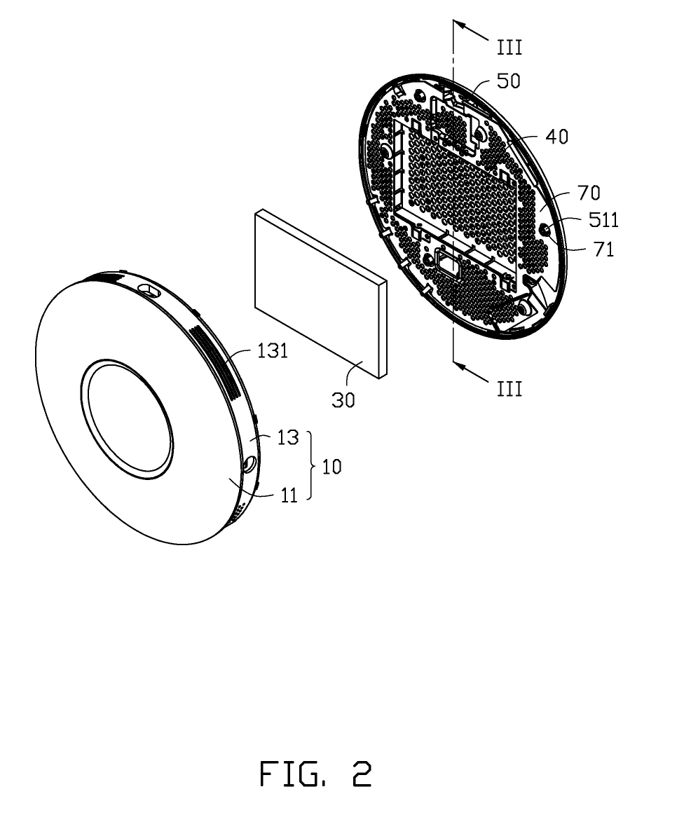

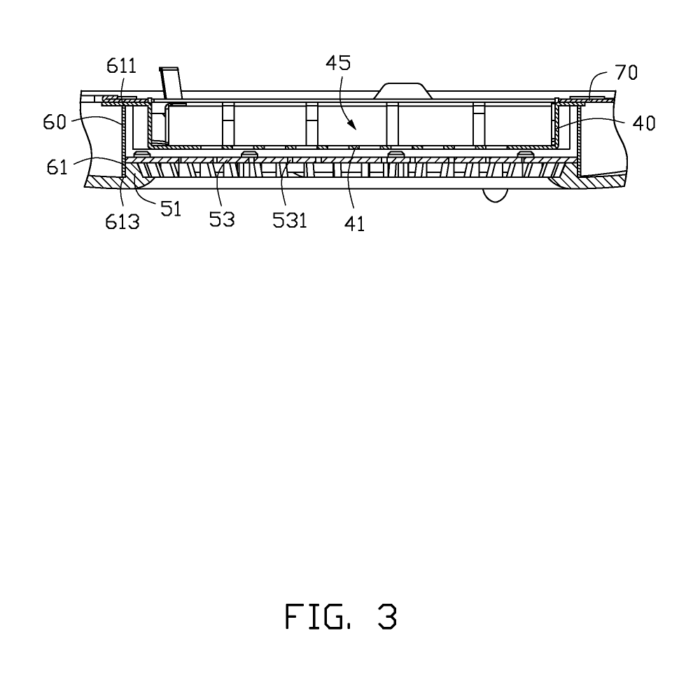

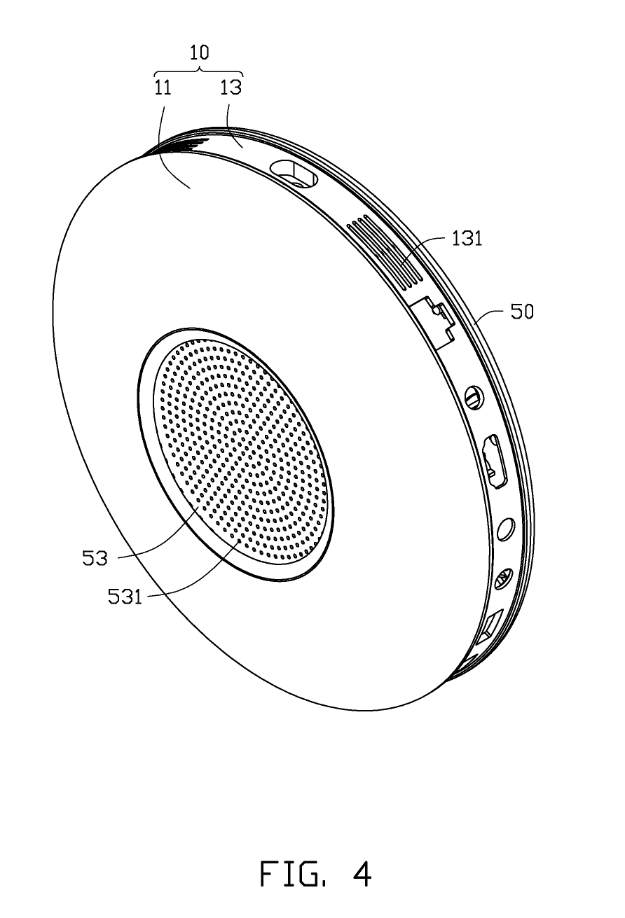

FIGS. 2-4 illustrate the electronic device in assembly. The air duct 60 is mounted to the rear cover 50. The main body 61 of the air duct 60 is around and abuts against the baffle plate 53. The bottom edge 613 abuts against the rear panel 51, and the air inlet is fluid communicated with the through hole 531.

A plurality of fasteners are inserted into the latching hole 153 of the bracket 40 and engaged in the securing holes 73 of the shielding cover 70. The opening 75 is aligned with the receiving space 45 of the bracket 40. The mounting holes 71 of the bracket 40 are engaged with the mounting posts 511 of the rear cover 50 in order to mount the bracket 40 to the rear cover 50, and the bracket 40 is supported on the retaining piece 513. A part of the bracket 40 is received in the air duct 60. The bottom edge 613 of the main body 61 abuts against the rear panel 51, the top edge 611 of the main body 61 abuts against the flanges 431, and the bracket 40 is engaged in the notches 65. The two clamping pieces 64 are engaged with two opposite side plates 43 of the bracket 40. The circuit board 20 is mounted on the front panel, and the fan 21 is aligned with the vent 131 of the sidewall 13.

The HDD 30 is mounted in the receiving space 45 through the opening 45 of the bracket 40. The rear cover 50 is mounted to the front cover 10, and the electronic device is assembled. The air duct 60 and the shielding cover 20 are located at two opposite sides of the bracket 40, and the bracket 40 and the shielding cover 70 are located between the air duct 60 and the circuit board 20. An axis direction of the air duct 60 is substantially perpendicular to the front panel 11 and the rear panel 51.

In use, the fan 21 operates to drive airflow to flow into the electronic device when the electronic device is in operation. An airflow path is defined by the through hole 531, the air inlet 62, the air outlet 63, and the bracket 40. In at least one embodiment, the air duct 60 can guide the airflow from the through hole 531 to the bracket 40 directly to flow out from the vent 131 via the shielding cover 70 and the circuit board 20. The airflow can take away heat generated by the HDD 30 when the airflow flows through the HDD 30, thereby dissipating heat for the HDD 30.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a rear cover defining a through hole;
a bracket configured to receive a HDD; and
an air duct defining an air inlet and air outlet;
wherein the bracket is located between the rear cover and the bracket, the air inlet is communicated with the through hole, the air outlet is aligned with the bracket, an air path is defined by the through hole, the air inlet, the air outlet, and the bracket, and a part of the bracket is received in the air duct.

2. The electronic device of claim 1, wherein the air duct comprises a top edge abutting against the bracket and a bottom edge abutting against the rear cover.

3. The electronic device of claim 2, wherein the air duct defines a notch extending from the top edge, the bracket is engaged in the notch.

4. The electronic device of claim 2, further comprising a shielding cover mounted to the rear cover, wherein the bracket is mounted on the shielding cover.

5. The electronic device of claim 4, wherein the rear cover comprises a rear panel and a baffle plate mounted on the rear panel, the shielding cover is supported by the rear panel, and the through hole is defined in the baffle plate.

6. The electronic device of claim 5, wherein the air duct comprises a main body, the top edge and the bottom edge are located at two opposite ends of the main body, the bottom edge abuts against the rear panel, and the main body is around and abuts against the baffle plate.

7. The electronic device of claim 4, wherein the bracket defines a receiving space to receive the HDD, the receiving space is defined by a bottom plate and a side plate, and a flange extends from the side plate and supported on the top edge of the air duct.

8. The electronic device of claim 7, wherein the shielding cover defines an opening corresponding to the receiving space to mount the HDD in the receiving space.

9. The electronic device of claim 4, further comprising a front cover mounted to the rear cover, wherein the shielding cover and air duct are located at two opposite sides of the bracket.

10. The electronic device of claim 9, further comprising a circuit board mounted in the front cover, wherein the shielding cover is located between the circuit board and the bracket.

11. An electronic device comprising:
a rear cover;
a bracket configured to receive a HDD and comprising a side plate; and
an air duct comprising a clamping piece engaged with the side plate;
wherein the air duct is located between the rear cover and the bracket and configured to guide airflow to the bracket.

12. The electronic device of claim 11, wherein the air duct comprises a main body, the main body comprises a top edge and a bottom edge, the clamping piece is defined by cutting the main body from the top edge, the bracket comprises a flange extending from the side plate, the top edge abuts against the flange, and the bottom edge abuts against the rear cover.

13. The electronic device of claim 12, wherein the rear cover comprises a rear panel and a baffle plate mounted on the rear panel, the bottom edge abuts against the rear panel, and the main body is around and abuts against the baffle plate.

14. The electronic device of claim 13, wherein the air duct defines an air inlet surrounded by the bottom edge and an air outlet surrounded by the top edge, and the air inlet and the outlet are communicated with a through hole defined in the baffle plate to guide the airflow to the bracket.

15. The electronic device of claim 11, further comprising a shielding cover mounted to the rear cover, wherein the bracket is mounted on the shielding cover.

16. The electronic device of claim 15, wherein the air duct and the shielding cover are located at two opposite sides of the bracket.

17. The electronic device of claim 15, wherein the bracket defines a receiving space to receive the HDD, and the shielding cover defines an opening corresponding to the receiving space to mount the HDD in the receiving space.

18. The electronic device of claim 11, further comprising a front cover mounted to the rear cover, wherein the air duct is substantially annular, and an axis direction of the air duct is substantially perpendicular to the front cover and the rear cover.

19. The electronic device of claim 18, further comprising a circuit board mounted in the front cover, wherein the circuit board and the air duct are located at two opposite sides of the bracket.

20. An electronic device comprising:
a front cover;
a rear cover cooperating with the front cover to form an interior space, the rear cover including a plurality of defined through holes communicating with the interior space;
a bracket positioned in the interior space and configured to receive and support a hard disk drive; and
an air duct having an air inlet and an air outlet;
wherein, the air duct is positioned between the bracket and the rear cover with the air inlet in fluid communication with at least a portion of the plurality of through holes and the air outlet is in fluid communication with at least a portion of the bracket creating an air path defined by at least a portion of the plurality of through holes, the air inlet, the air outlet and at least a portion of the bracket.
